(19) United States
(12) Patent Application Publication
(10) Pub. No.: US 2021/0264248 A1
(43) Pub. Date: Aug. 26, 2021

(54) MACHINE LEARNING SYSTEM AND METHOD FOR PREDICTING LAUNCH WINDOWS

(71) Applicant: Michael Limotta, Solvang, CA (US)

(72) Inventor: Michael Limotta, Solvang, CA (US)

(21) Appl. No.: 16/798,379

(22) Filed: Feb. 23, 2020

(51) Int. Cl. G06N 3/08; G06N 3/04

(52) U.S. Cl. CPC G06N 3/08; G06N 3/0445; G06N 3/0454

(57) ABSTRACT

A launch window prediction system includes a first computer processor environment configured to preprocess data for providing to a physics-based model, the first computer processor environment includes a graphical user interface (GUI) for receiving input from a user. The launch window prediction system also includes a second computer processor environment running at least partially trained neural network software that has been trained to perform decision making on whether to launch or not to launch during a launch window, the second computer processor environment receiving input information from the first computer processor environment. The launch window prediction system further includes a third computer processor environment configured to receive data related to the output from the neural network of the second computer processor environment, the third computer processor environment provides user useable output through a GUI running on the third computer processor environment.

### BACKGROUND

A launch window is the time period on a given day during which a particular vehicle (Rocket, Space Shuttle, etc.) must be launched in order to reach its intended target. The launch window specifically indicates the time frame on a given day in the launch period that the rocket can launch to reach its intended orbit. This can be as short as a second (referred to as an instantaneous window) or even the entire day. For operational reasons, the launch window almost always is limited to no more than a few hours. The launch window can stretch over two calendar days (ex: start at 11:30 p.m. and end at 12:30 a.m.). Launch windows are rarely exactly the same times each day.

Conventional methods for determining launch windows include analyzing various sources for weather forecasts, range site activities and conditions specific to the launch vehicle. Weather forecasts are largely dependent on public data (with the exclusion of launch-day high altitude weather balloons). Range site activities might have restricted access—if launch site is located on an Air Force Base. Vehicle Parameters are known in advance (such as size, weight, aspect ratio, etc.), coupled with weather this makes each launch unique. For example, high altitude crosswinds could be tolerable for a vehicle with low aspect ratio but not for one with high aspect ratio. Compiling all of the weather data from various sources, the range site data, the vehicle parameter data and making a launch window prediction on whether the launch is a go or no go during the launch window is a cumbersome task which often requires multiple personnel to complete.

Accordingly, there is a need for ways to simplify the launch window prediction based on weather inputs, the particular launch parameters, and the like. There is also a need for reducing the computational time as well as the time for setting up launch window prediction system for a particular launch.

### SUMMARY

An illustrative embodiment relates to a launch window prediction system. The launch window prediction system includes a first computer processor environment configured to preprocess data for providing to a physics-based model, the first computer processor environment includes a graphical user interface (GUI) for receiving input from a user. The launch window prediction system also includes a second computer processor environment running at least partially trained neural network software that has been trained to perform decision making on whether to launch or not to launch during a launch window, the second computer processor environment receiving input information from the first computer processor environment. The launch window prediction system further includes a third computer processor environment configured to receive data related to the output from the neural network of the second computer processor environment, the third computer processor environment provides user useable output through a GUI running on the third computer processor environment.

An illustrative embodiment also relates to a method of decision making for launching a launch vehicle during a launch window. The method includes receiving input from a user through a graphical user interface (GUI) running on a first computer environment. The method also includes preprocessing data, by the first computer processor environment and receiving input information, by a second computer processor environment, from the first computer processor environment. Further, the method includes running at least partially trained neural network software, by a second computer processor environment, that has been trained to make a decision as to launch or not to launch a launch vehicle during a launch window. Further still, the method includes receiving data, by a third computer processor environment, the data being related to the output from the neural network of the second computer processor environment. Yet further still, the method includes providing post processing, by a third computer processor environment, the post processing based on inputs received from a user through a GUI running on the third computer processor environment.

A launch window prediction system includes a means for receiving input from a user through a graphical user interface (GUI) running on a first computer environment and a means for preprocessing data, by the first computer processor environment. The launch window prediction system also includes a means for receiving input information, by a second computer processor environment, from the first computer processor environment and a means for running at least partially trained neural network software, by a second computer processor environment, that has been trained to make a decision as to launch or not to launch a launch vehicle during a launch window. The launch window prediction system further includes a means for receiving data, by a third computer processor environment, the data being related to the output from the neural network of the second computer processor environment. Yet further still, the launch window prediction system includes a means for providing post processing, by a third computer processor environment, the post processing based on inputs received from a user through a GUI running on the third computer processor environment.

In addition to the foregoing, other system aspects are described in the claims, drawings, and text forming a part of the disclosure set forth herein. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF THE DRAWINGS

FIG. 1 is an illustrative embodiment of a system for generating a neural network-based launch window predictor.

FIG. 2 is an illustrative embodiment of a flow diagram for pre-processing of data for a neural network-based launch window predictor.

FIG. 3 is an exemplary embodiment of a flow diagram for an artificial neural network launch window predictor.

The use of the same symbols in different drawings typically indicates similar or identical items unless context dictates otherwise.

### DETAILED DESCRIPTION

In accordance with illustrative embodiments, the system and methods described are advantageous to reduce delays for rocket launches by providing recommendations of time/dates where the probability of a “scrub” (no-go, no launch) is lower. Using the described systems or methods provides recommendations that are provided days and/or weeks before the start of the mission-desired launch window. The advantage of using the neural network as compared to conventional methodologies is that the ANN is able to learn a data intensive nonlinear mapping to a singular recommendation of whether to launch or not during a specific launch window.

An artificial neural network (ANN) is a system that, due to its topological structure, can adaptively learn nonlinear mappings from input to output space when the network has a large database of prior examples from which to draw. In some sense, an ANN simulates human functions such as learning from experience, generalizing from previous to new data, and abstracting essential characteristics from inputs containing irrelevant data. Using an ANN for propulsion system modelling, without the need for significant physical modeling or insight, may be highly advantageous because in an ANN, the source terms are highly nonlinear functions of the input parameters. Hence, linear interpolation is not an appropriate approach to their modeling, unless each parameter of the data set is divided into an enormous number of small increments.

The basic architecture of a neural network includes layers of interconnected processing units called neurons (comparable to the dendrites in the biological neuron) that transform an input vector [c1, c2, . . . , cM]T into an output vector [a1n, a2n, . . . , aSn]T. Neurons without predecessors are called input neurons and constitute the input layer. All other neurons are called computational units because they are developed from the input layer. A nonempty subset of the computational units is specified as the output units. All computational units that are not output neurons are called hidden neurons.

The universal approximation theorem states that a neural network with one hidden layer, utilizing a sigmoid transfer function, is able to approximate any continuous function f: R M→R S2 (where M and S2 are dimensions of the function domain and range, respectively) in any domain, with a given accuracy based, in part, on the amount of training data. Features of the input data are extracted in the hidden layer with a hyperbolic tangent transfer function and in the output layer with a purely linear transfer function. Based on the theorem and thanks to the topological structure of the neural network, one can generate complex data dependencies without performing time-consuming computations. However, any neural network application depends on the training or learning algorithm. The learning algorithm is the repeated process of adjusting weights to minimize the network errors. These errors are defined by e=t−a, where t is the desired network output vector and a=a(c, [W]) is the actual network output vector, a function of the input data and network weights. This weight adjustment is repeated for many training samples and is stopped when the errors reach a sufficiently low level.

The majority of neural network applications are based on the backpropagation algorithm. The term backpropagation refers to the process by which derivatives of the network error, with respect to network weights and biases, are calculated, from the last layer of the network to the first. The Levenberg-Marquardt backpropagation scheme is one such technique used to optimize neural network weights however any other applicable method may be used without departing from the scope of the invention.

In accordance with illustrative embodiments Artificial Neural Network (ANN) models may be stored on a cloud server with connections over the internet to end-user devices. These ANNs may be used to provide launch window predictions much prior to the launch window itself.

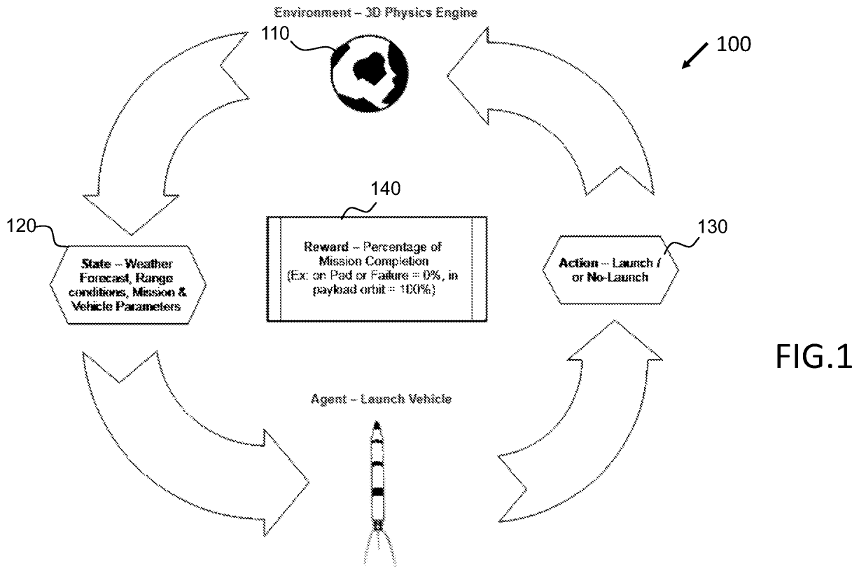

Referring to FIG. 1, an illustration of a launch window prediction learning platform 100 is depicted. In such a platform 100, the Environment or a 3D physics model of the Environment 110 may provide information to the ANN depicted as State 120. State 120 may include but is not limited to Weather forecasts, Range Conditions, Mission and Vehicle parameters. Any or all of the State information may be raw data or preprocessed, modelled, interpolated, extrapolated, or approximated data. The ANN training sets may include outputs which are go or no-go for launch and in the deep reinforcement learning construct a reward 140 may be used which may be percentage of mission completion e.g on pad=0% and in Payload orbit=100%.

In accordance with an illustrative embodiment, any of a variety of techniques may be used to train the ANNs including, but not limited to Reinforcement Learning, Deep Reinforcement Learning, Levenberg-Marquardt, Gradient Descent-based learning methods for back propagation, Newton, Quasi-Newton, Conjugate Gradient, etc. The models themselves may consist of Deep Neural Networks and Recurrent Neural Networks. Some of the input data, both for training and in use may require preprocessing. For example, simulation of environment or weather and rocket dynamics may be simulated in a 3D Physics Engine to provide predictions of rocket dynamics given the predicted weather model. This is just one example of preprocessing of data and the scope of the invention is not limited to using this specific preprocessed data or preprocessed data.

Under the assumption that the physics simulation 110 is ideal and matches most real-world conditions, the model should perform similar to the simulated one. However, as new data is obtained, or requirements change, those can be inputted into the simulation and re-run.

In accordance with an illustrative embodiment weather forecasts may be predicted with a Recurrent Neural Network, due to the data source having a time-series. As weather conditions change, the RNN will provide new forecasts. Training the neural networks may be done using Adam optimization or classical stochastic gradient descent among many other possible training methodologies.

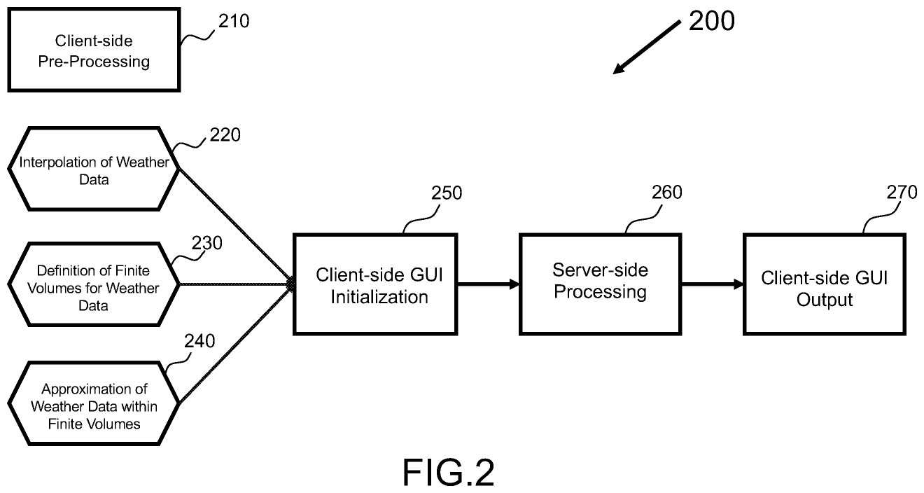

Referring now to FIG. 2, a flow 200 for preprocessing of data may be used in client-side preprocessing 210. The RL model must handle large datasets for Weather conditions. Other inputs such as range conditions, mission and vehicle parameters are static variables and do not require methods for pre-processing. Weather conditions at the range and nearby sites will be obtained and stored digitally as states for finite volumes of the atmosphere. Interpolation methods 220 may be used to generate data where none exists. From the data, finite volumes 230 are generated within the 3D Physics Engine that contain relevant atmospheric conditions (e.g., Pressure, Temperature, Density, Humidity, Moisture, Electric Charge, etc.). The size of these finite volumes can be decreased to increase the resolution of the simulation and therefore provide higher order accuracy, if needed. Approximations of weather data 240 may then be made, before providing all of the pre-processed data to client-side GUI initialization, 250, server-side processing, and client-side GUI client-side GUI Output 270.

In some exemplary embodiments, more than one neural network can be used each carrying out different portions of the simulation and linked from output of one network to inputs of another network. Also, any of a variety of neural network paradigms may be applied in any combination in order to most effectively provide high performance simulation results.

The high degree of nonlinearity and adaptivity of the neural network paradigms applied provide the ability to model the highly nonlinear nature of the environmental conditions that are being modelled. The training of the networks may be done using any of a variety of methods including, but not limited to Adam optimization and stochastic gradient descent methods.

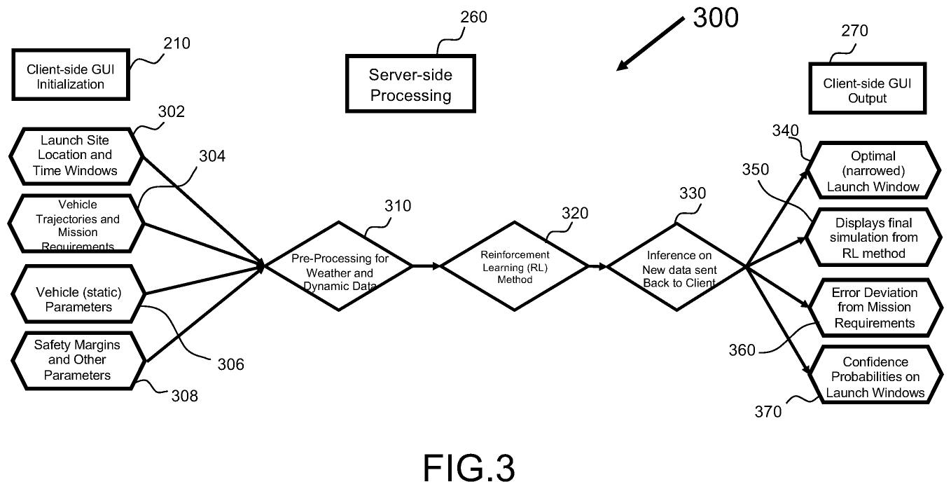

Referring now to FIG. 3, a more detailed view of the flow diagram of FIG. 2 is provided. In flow 300, preprocessing is provided in any of the same ways as discussed above with respect to FIG. 2 or may include providing launch site location and time windows 302, or other parameters 308. Once the preprocessing has been completed, information is sent to the server, the server accepts a request over TCP/IP 310 and implements a Reinforcement Learning (RL) method which includes a Deep Reinforcement Learning method 320. The chosen RL model may be is a chosen network paradigm, but may be any of a variety of other network paradigms without departing from the scope of the invention. Once the data has been run through the neural network models (server side processing 260), inference on the new data set is sent back to the client computer where and provided in client-side GUI 270. The output may include but is not limited to Optimal (narrowed) Launch Window 340, Displays final simulation from the RL method 350, error deviation from Mission Requirements 360, and Confidence probabilities on the launch windows 370, among many others. The inputs and outputs are not limited to those described but may be any of a variety of such inputs and outputs depending on design goals trying to be achieved.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently.

Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A launch window prediction system, comprising:
a first computer processor environment configured to preprocess data for providing to a physics-based model, the first computer processor environment including a graphical user interface (GUI) for receiving input from a user;
a second computer processor environment running at least partially trained neural network software that has been trained to perform decision making on whether to launch or not to launch during a launch window, the second computer processor environment receiving input information from the first computer processor environment; and
a third computer processor environment configured to receive data related to the output from the neural network of the second computer processor environment, the third computer processor environment providing user useable output through a GUI running on the third computer processor environment.

2. The launch window prediction system of claim 1, wherein the first and third computer processor environments are running on the same computer.

3. The launch window prediction system of claim 1, wherein the first, second, and third computer processor environments are running on the same computer.

4. The launch window prediction system of claim 1, wherein the second computer processor environment may run one or more of more than one configuration of neural network software.

5. The launch window prediction system of claim 1, wherein the neural network software comprises a multilayer perceptron network.

6. The launch window prediction system of claim 1, wherein the neural network software comprises a recurrent neural network.

7. The launch window prediction system of claim 1, wherein the neural network is trained based on weather data from a physics model.

8. The launch window prediction system of claim 1, wherein the neural network is trained based on estimated launch vehicle dynamics from a launch vehicle dynamics model.

9. The launch window prediction system of claim 1, wherein the neural network is trained based on range conditions.

10. The launch window prediction system of claim 1, wherein the neural network is trained based on vehicle parameters.

11. The launch window prediction system of claim 1, wherein the neural network output includes a recommendation of whether to launch or not to launch.

12. The launch window prediction system of claim 1, wherein the preprocessing includes at least one of defining finite volumes for weather data, and predicting future weather states and conditions.

13. A method of decision making for launching a launch vehicle during a launch window, comprising:
receiving input from a user through a graphical user interface (GUI) running on a first computer environment;
preprocessing data, by the first computer processor environment;
receiving input information, by a second computer processor environment, from the first computer processor environment;
running at least partially trained neural network software, by a second computer processor environment, that has been trained to make a decision as to launch or not to launch a launch vehicle during a launch window;
receiving data, by a third computer processor environment, the data being related to the output from the neural network of the second computer processor environment; and
providing post processing, by a third computer processor environment, the post processing based on inputs received from a user through a GUI running on the third computer processor environment.

14. The method of claim 1, further comprising:
training the neural network based on weather data from a physics model.

15. The method of claim 1, further comprising:
training the neural network based on estimated launch vehicle dynamics from a launch vehicle dynamics model.

16. The method of claim 1, further comprising:
training the neural network based on range conditions.

17. The method of claim 1, further comprising:
training the neural network is trained based on vehicle parameters.

18. The method of claim 1, further comprising:
Outputting from the neural network data representative of a recommendation of whether to launch or not to launch.

19. The method of claim 1, further comprising at least one of:
defining finite volumes for weather data as part of the preprocessing, and
predicting future weather states and conditions.

20. A launch window prediction system, comprising:
a means for receiving input from a user through a graphical user interface (GUI) running on a first computer environment;
a means for preprocessing data, by the first computer processor environment;
a means for receiving input information, by a second computer processor environment, from the first computer processor environment;
a means for running at least partially trained neural network software, by a second computer processor environment, that has been trained to make a decision as to launch or not to launch a launch vehicle during a launch window;
a means for receiving data, by a third computer processor environment, the data being related to the output from the neural network of the second computer processor environment; and
a means for providing post processing, by a third computer processor environment, the post processing based on inputs received from a user through a GUI running on the third computer processor environment.
